(19) United States
(12) Patent Application Publication
(10) Pub. No.: US 2007/0229424 A1
(43) Pub. Date: Oct. 4, 2007

(54) DISPLAY DEVICE INCLUDING OPTICAL SENSOR IN PIXEL

(75) Inventors: Hirotaka Hayashi, Fukaya-shi (JP); Yoshitaka Yamada, Fukaya-shi (JP); Takashi Nakamura, Saitama-shi (JP); Norio Tada, Kumagaya-shi (JP); Hiroki Nakamura, Ageo-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/566,266

(22) Filed: Dec. 4, 2006

(30) Foreign Application Priority Data
Mar. 30, 2006 (JP) 2006-095370

(51) Int. Cl. G09G 3/36

(52) U.S. Cl. 345/89

(57) ABSTRACT

In order to maintain display performance of a display device, the display device includes an optical sensor disposed across three sub-pixels of red, green and blue colors in each pixel. This configuration makes it possible to adjust the aperture ratios of the respective sub-pixels, and thus to make the amount of light passing through the respective sub-pixels closer to one another. In other words, the white balance can be maintained.

### CROSS-REFERENCE TO RELATED APPLICATIONS

This application is based upon and claims the benefit of priority from Japanese Patent Application No. 2006-95370 filed on Mar. 30, 2006; the entire contents of which are incorporated herein by reference.

### BACKGROUND OF THE INVENTION

1. Field of the Invention

The present invention relates to a display device having a function of reading light entering from a screen by using a sensor included in each pixel.

2. Description of the Related Art

Display devices, such as the display device described in Japanese Patent Application Laid-Open Official Gazette No. 2004-93894, have been developed in recent years. Such a display device includes not only pixels each located at an intersection of a scan line and a signal line, but also optical sensors in the respective pixels. The optical sensors detect the fact that a finger of a user comes close to, for example, a touch panel.

In a display device of the prior art, each pixel includes red, green and blue sub-pixels and an optical sensor. Color filters corresponding to the respective colors are disposed respectively in the pixels. Light passing through the color filters is collectively used for displaying a color image.

In the display device of the prior art, however, the optical sensor is disposed in a single sub-pixel of three sub-pixels. Accordingly, aperture ratios of the respective sub-pixels are not uniform. When an image is displayed, the amount of light passing through the sub-pixel in which an optical sensor is disposed is less than the amount of light passing through the sub-pixel in which an optical sensor is not disposed. This results in a problem that white balance cannot be maintained.

### SUMMARY OF THE INVENTION

An object of the present invention is to adjust the amount of light passing through the respective sub-pixels in each pixel when an image is displayed on a display device, and thus to maintain display performance.

A first aspect of the present invention is that a display device includes: a pixel region having a plurality of pixels; three sub-pixels of red, green and blue colors disposed in each of the pixels; and an optical sensor disposed across the three sub-pixels.

In the present invention, the optical sensor is disposed across the three sub-pixels in each of the pixel. This configuration makes it possible to adjust the aperture ratios of the respective sub-pixels, and thus to make the amount of light passing through the respective sub-pixels closer to one another, when an image is displayed.

A second aspect of the present invention is that a display device includes: a pixel region having a plurality of pixels; three sub-pixels of red, green and blue colors disposed in each of the pixels; an optical sensor disposed in any one of the three sub-pixels; and dummy patterns respectively disposed in the sub-pixels, in each of which the optical sensor is not disposed.

In the present invention, the optical sensor is disposed in any one of the three sub-pixels in each of the pixel, and the dummy patterns are respectively disposed in the sub-pixels, in each of which the optical sensor is not disposed. This configuration makes it possible to adjust the aperture ratios of the respective sub-pixels, and thus to make the amount of light passing through the respective sub-pixels close to one another, when an image is displayed.

A third aspect of the present invention is that a display device includes: a pixel region having a plurality of pixels; three sub-pixels of red, green and blue colors disposed in each of the pixels, and any one of which three sub-pixels has an area larger than the other two sub-pixels; and an optical sensor disposed in the sub-pixel having the larger area.

In the present invention, the optical sensor is disposed in one of the three sub-pixels, which has the area larger than the other two sub-pixels. Accordingly, the amount of light passing through the pixels can be made closer to one another when an image is displayed.

### BRIEF DESCRIPTION OF THE DRAWINGS

FIG. 1 shows a schematic circuit configuration of a display device of a first embodiment.

FIG. 2 shows an equivalent circuit of a pixel including an optical-sensor of FIG. 1.

FIG. 3 shows a plan view of the pixel including the optical-sensor of FIG. 2.

FIG. 4 shows a plan view of a pixel disposed in a display device of Comparative Example.

FIG. 5 shows a chromaticity diagram in the XYZ calorimetric system.

FIG. 6 shows a plan view of a pixel disposed in a display device of a second embodiment.

FIG. 7 shows a plan view of a pixel disposed in a display device of a third embodiment.

### DESCRIPTION OF THE EMBODIMENT

### First Embodiment

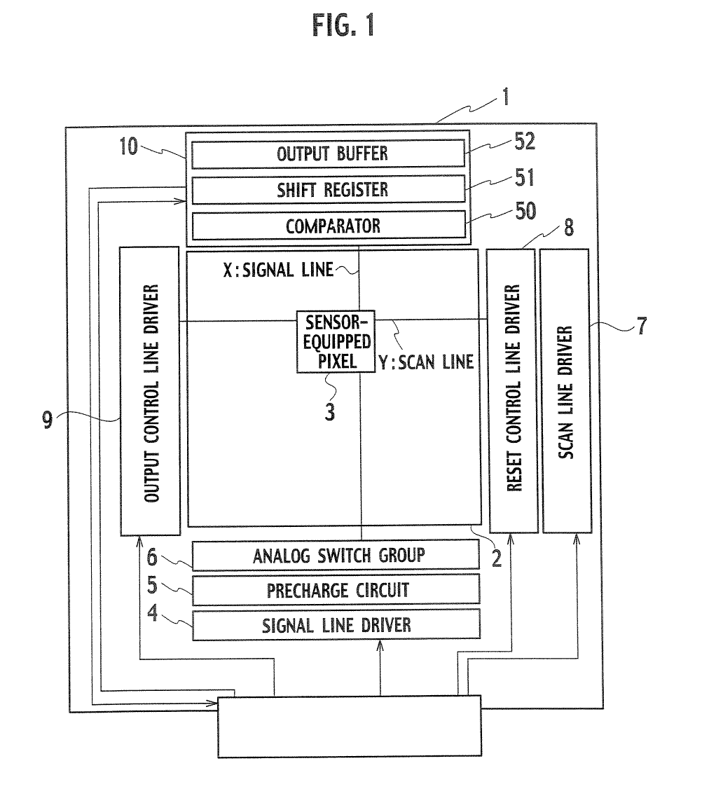

As shown in a block diagram of FIG. 1, the display device of this embodiment includes a pixel region 2 having a plurality of pixels and circuit regions entirely surrounding the pixel region 2 on a glass substrate 1.

In the pixel region 2, scan lines Y and signal lines X are disposed intersecting each other. At each of the intersections, a pixel 3 including an optical sensor is disposed. Here, an XGA-type liquid crystal display panel is adopted as an example of the display device. In the pixel region 2, 768 scan lines and 3,072 signal lines are disposed intersecting each other.

In the circuit region below the pixel region 2, a signal line driver 4, a precharge circuit 5, and an analog switch group 6 are disposed. The signal line driver 4 supplies an image signal to each of the signal lines X. The precharge circuit 5 supplies a precharge voltage to each of the signal lines X. The analog switch group 6 consists of a plurality of analog switches each switching the connection and disconnection between each signal line X and the corresponding output line of the signal line driver 4, or between each signal line X and the corresponding output line of the precharge circuit 5.

In the circuit region to the right of the pixel region 2, a scan line driver 7 and a reset control line driver 8 are disposed. The scan line driver 7 generates control signals, and sequentially outputs the control signals to the scan lines Y of the respective rows. The reset control line driver 8 includes a shift register and a buffer circuit. This buffer circuit sequentially outputs reset control signals to reset control lines of the respective rows, based on shift pulses sequentially propagating through the shift register.

In the circuit region to the left of the pixel region 2, an output control line driver 9 is disposed. The output control line driver 9 includes a shift register and a buffer circuit. The buffer circuit sequentially outputs output control signals to the output control lines, based on shift pulses sequentially propagating through the shift register.

In the circuit region above the pixel region 2, a detection circuit 10 is disposed. The detection circuit 10 includes a comparator 50, a shift register 51 and an output buffer 52. The comparator 50 compares potentials of the signals outputted from optical sensors with the reference voltage, and outputs the results thereof. The results are stored in each stage of the shift register 51. The shift register 51 outputs data in synchronization with a control clock bit by bit. The output buffer 52 adjusts the amplitude of an output signal from the shift register 51 so that the output signal matches an interface of an external IC, or amplifies the same so that the output signal is appropriate for driving load up to the external IC.

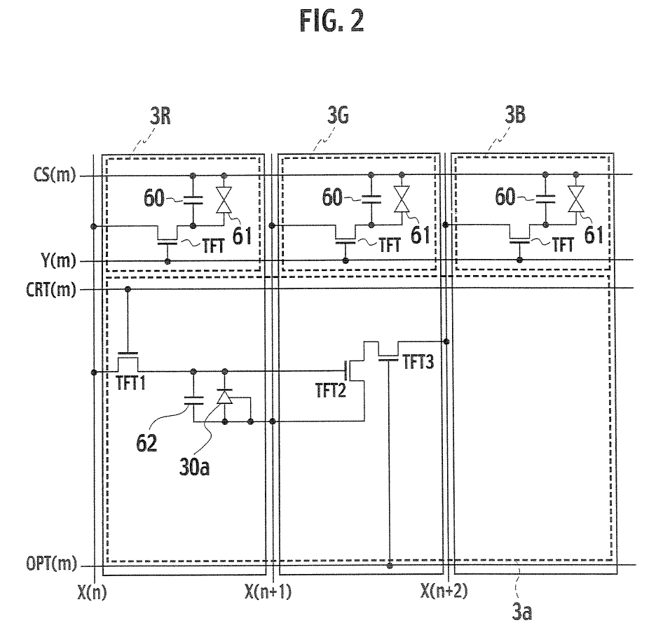

Subsequently, descriptions will be provided for the configuration of a pixel including an optical sensor. As shown in a circuit diagram of FIG. 2, a pixel 3 includes a red sub-pixel 3R, a green sub-pixel 3G, a blue sub-pixel 3B, and an optical sensor 3a.

The sub-pixel 3R includes a thin film transistor TFT, an auxiliary capacitor 60, and a liquid crystal capacitor 61, which are disposed at the intersection of a scan line Y(m) and a signal line X(n). Note that an attached character “m” in FIG. 2 is a positive integer, and shows the order of the scan lines, and the attached character “n” in FIG. 2 is a positive integer, and shows the order of the signal lines. Here, an n-channel MOS-FET is adopted as an example of the TFT. To the drain of the TFT, the auxiliary capacitor 60, the liquid crystal capacitor 61 and a pixel electrode are connected in parallel. To the source of the TFT, the corresponding signal line X(n) is connected. To the gate of the TFT, the corresponding scan line Y(m) is connected. A common voltage is supplied to each of the auxiliary capacitor 60 and the liquid crystal capacitor 61 through a supply line CS(m). In this sub-pixel, a red color filter is disposed corresponding to the area of the sub-pixel 3R in order to display red image signals.

The sub-pixel 3G includes a TFT, an auxiliary capacitor 60, and a liquid crystal capacitor 61, which are disposed at the intersection of the scan line Y(m) and a signal line X(n+1). To the drain of the TFT, the auxiliary capacitor 60, the liquid crystal capacitor 61 and a pixel electrode are connected in parallel. To the source of the TFT, the corresponding signal line X(n+1) is connected. To the gate of the TFT, the corresponding scan line Y(m) is connected. In this sub-pixel, a green color filter is disposed corresponding to the area of the sub-pixel 3G in order to display green image signals.

The sub-pixel 3B includes a TFT, an auxiliary capacitor 60, and a liquid crystal capacitor 61, which are disposed at the intersection of the scan line Y(m) and a signal line X(n+2). To the drain of the TFT, the auxiliary capacitor 60, the liquid crystal capacitor 61 and a pixel electrode are connected in parallel. To the source of the TFT, the corresponding signal line X(n+2) is connected. To the gate of the TFT, the corresponding scan line Y(m) is connected. In this sub-pixel, a blue color filter is disposed corresponding to the area of the sub-pixel 3B in order to display blue signals.

The optical sensor 3a is disposed across the three sub-pixels and includes a switching element TFT 1, a source follower amplifier TFT 2, a switching element TFT 3, a light-receiving element 30a and a capacitor 62. The TFTs 1 to 3 are thin film transistors, and an n-channel MOS-FET is adopted as an example thereof. The source follower amplifier TFT 2 is disposed at an output portion of the optical sensor 3a. The light-receiving element 30a and the capacitor 62 are disposed in parallel, and are connected to a portion between the gate and source of the source follower amplifier TFT 2.

A reset control line CRT(m) is connected to the gate of the switching element TFT 1. The reset control line CRT(m) controls an on-and-off operation of the switching element TFT 1. In a case where the switching element TFT 1 is turned on, a precharge voltage is supplied to the capacitor 62 from the precharge circuit 5 through the signal line X(n). The light-receiving element 30a receives light entering from a screen, and converts the light into a photocurrent depending on the amount of the received light. This photocurrent causes the voltage level of the capacitor 62 to change.

The source follower amplifier TFT 2 amplifies the potential of the capacitor 62. An output control line OPT(m) is connected to the gate of the switching element TFT 3. The output control line OPT(m) controls an on-and-off operation of the switching element TFT 3. In a case where the switching element TFT 3 is turned on, the voltage level of the capacitor 62, which is amplified by the source follower amplifier TFT 2, is outputted to the detection circuit 10 through the signal line X(n+2).

With this configuration, the optical sensor 3a included in each pixel reads the brightness of light entering from the screen, for instance, in a case where a finger of a user comes close to the pixel region 2. Accordingly, the display device can detect a region where the finger is located in the pixel region 2.

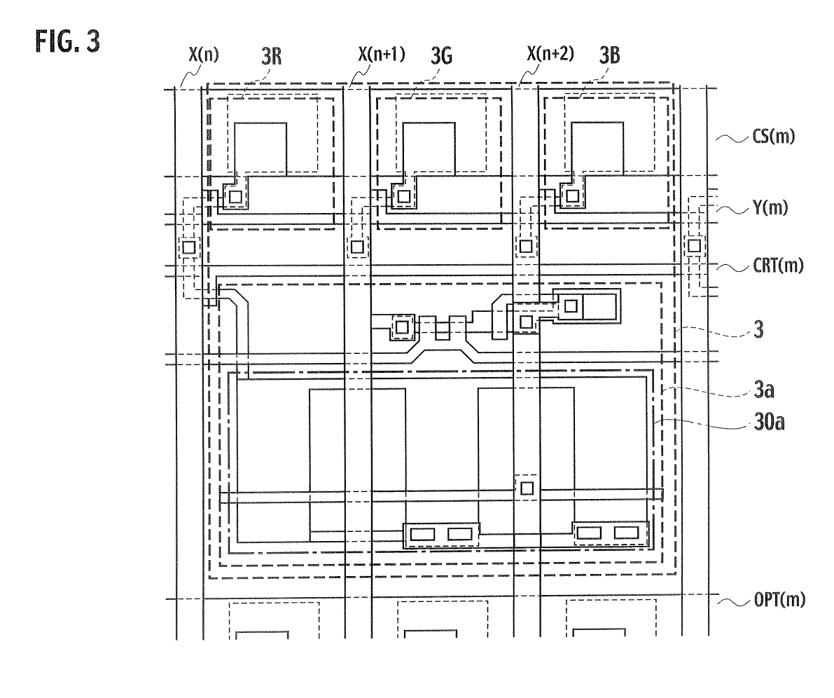

Subsequently, descriptions will be provided for the configuration of the optical sensor 3a. As shown in a layout diagram of the pixel of FIG. 3, the optical sensor 3a is disposed across the three sub-pixels 3R, 3G and 3B. In the optical sensor 3a, the light-receiving element 30a occupies the largest area and blocks light such as backlight when an image is displayed. This configuration makes it possible to adjust the aperture ratios of the respective sub-pixels, and thus to make the amount of light passing through the respective sub-pixels closer to one another when an image is displayed.

A PIN photodiode is an example of the light-receiving element 30a. The PIN photodiode includes an i-region between a p-region and an n-region. The p-region is a p⁺-region having a higher concentration of p-type impurities. The n-region is an n⁺-region having a higher concentration of n-type impurities. The i-region is a p-region having a lower concentration of p-type impurities. Accordingly, the light-receiving sensitivity is increased.

### Comparative Example

Subsequently, a display device of Comparative Example will be described in order to clarify the effect of the display device of the first embodiment.

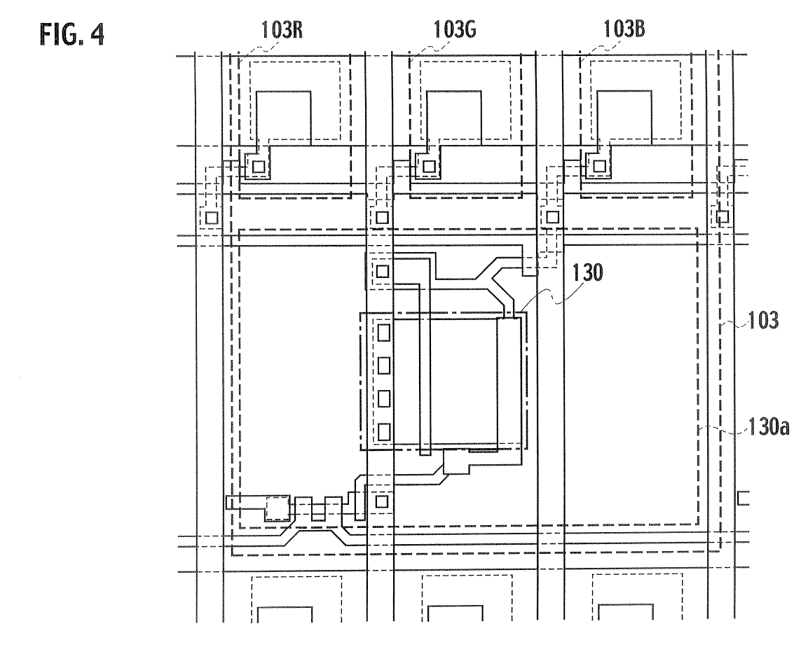

As shown in a layout diagram of FIG. 4, a pixel 103 of the display device of Comparative Example includes a red sub-pixel 103R, a green sub-pixel 103G, a blue sub-pixel 103B and an optical sensor 130a. The optical sensor 130a includes a light-receiving element 130. The light-receiving element 130 is disposed, for example, in the green sub-pixel 103G. The light-receiving element 130 occupies the largest area in the optical sensor 130a. Hence, the aperture ratio of the sub-pixel 103G is smaller than that of the sub-pixel 103R or 103B. When a color image is displayed, the amount of light passing through the sub-pixel 103G in which an optical sensor is disposed is less than the amount of light passing through the sub-pixel 103R or 103B in which an optical sensor is not disposed.

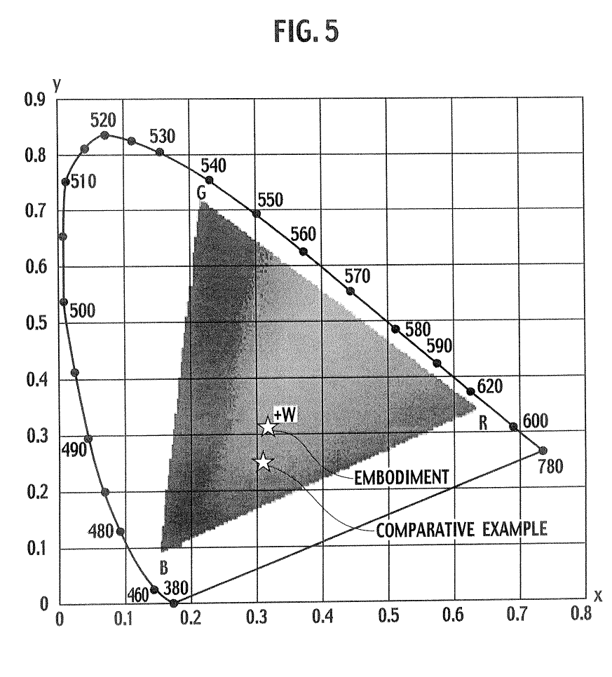

FIG. 5 shows a chromaticity diagram in the XYZ calorimetric system. The triangle is formed by connecting the chromaticity coordinates of the respective colors of red (R), green (G) and blue (B). The point W in the triangle shows an optimum whiteness of the white color. “Embodiment” shows the whiteness displayed by the display device of the first embodiment. “Comparative Example” shows the whiteness displayed by the display device of FIG. 4. The whiteness of “Comparative Example” is located in a point far from the point W. This indicates that the white color displayed by using “Comparative Example” is purplish white, and that the white balance is lost. On the other hand, the whiteness of “Embodiment” is located near the point W. This indicates that the white color displayed by using “Embodiment” is excellent, and that the white balance is maintained.

As described hereinabove, in the first embodiment, the optical sensor 3a is disposed across the three sub-pixels 3R, 3G and 3B. This configuration makes it possible to adjust the aperture ratios of the respective sub-pixels, and thus to make the amount of light passing through the respective pixels closer to one another when a color image is displayed. Hence, it is possible to maintain the display performance.

### Second Embodiment

A basic configuration of a display device of a second embodiment is similar to that described in the first embodiment. The second embodiment is different from the first embodiment in that dummy patterns are disposed in sub-pixels in each of which no optical sensor is disposed.

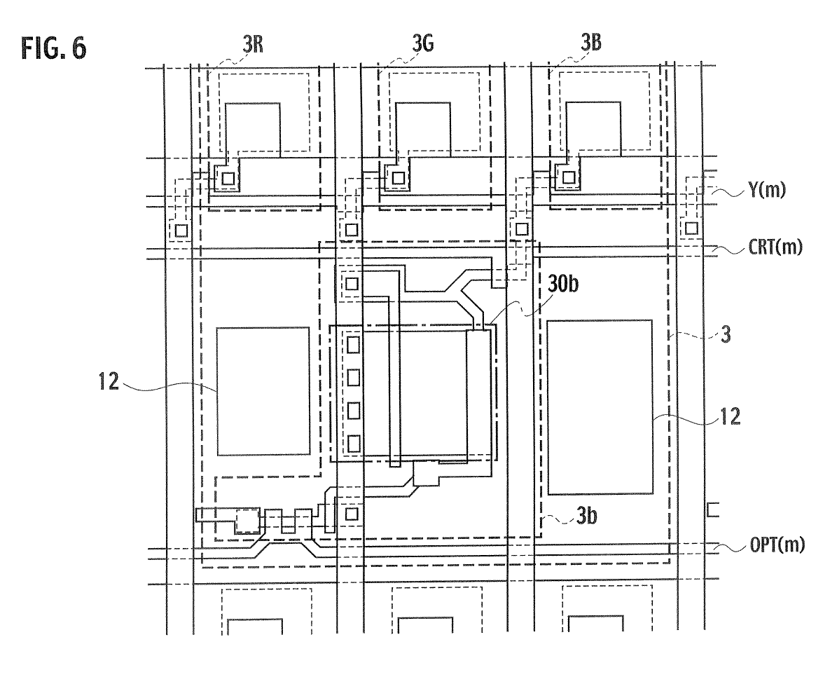

As shown in a layout diagram of a pixel of FIG. 6, an optical sensor 3b is disposed in a green sub-pixel 3G. Dummy patterns 12 are respectively disposed in sub-pixels 3R and 3B, in each of which the optical sensor 3b is not disposed. The dummy pattern 12 has a function of blocking external light such as backlight when an image is displayed. This configuration makes it possible to adjust the aperture ratios of the respective sub-pixels, and thus to make the amount of light passing through the respective sub-pixels closer to one another.

As describe above, in the second embodiment, the optical sensor 3b is disposed in the green sub-pixel 3G, and the dummy patterns 12 are respectively disposed in the sub-pixels 3R and 3B, in each of which the optical sensor 3b is not disposed. This configuration makes it possible to adjust the aperture ratios of the respective pixels, and thus to make the amount of light passing through the respective sub-pixels closer to one another. Hence, it is possible to maintain the white balance regarded as the display performance.

Note that, in the second embodiment, the display device has the configuration in which the optical sensor 3b is disposed in the green sub-pixel 3G, but the configuration is not limited to this. It is also possible to adopt a configuration in which the optical sensor 3b is disposed in the red sub-pixel 3R or the blue sub-pixel 3B, as long as the optical sensor 3b is disposed in any one of the sub-pixels 3R, 3G and 3B, and the dummy patterns 12 are respectively disposed in the sub-pixels, in each of which the optical sensor 3b is not disposed.

### Third Embodiment

A basic configuration of a display device of a third embodiment is similar to that described in the first embodiment. The third embodiment is different from the first embodiment in that an optical sensor is disposed in a sub-pixel of three sub-pixels, the sub-pixel having an area larger than the other two pixels.

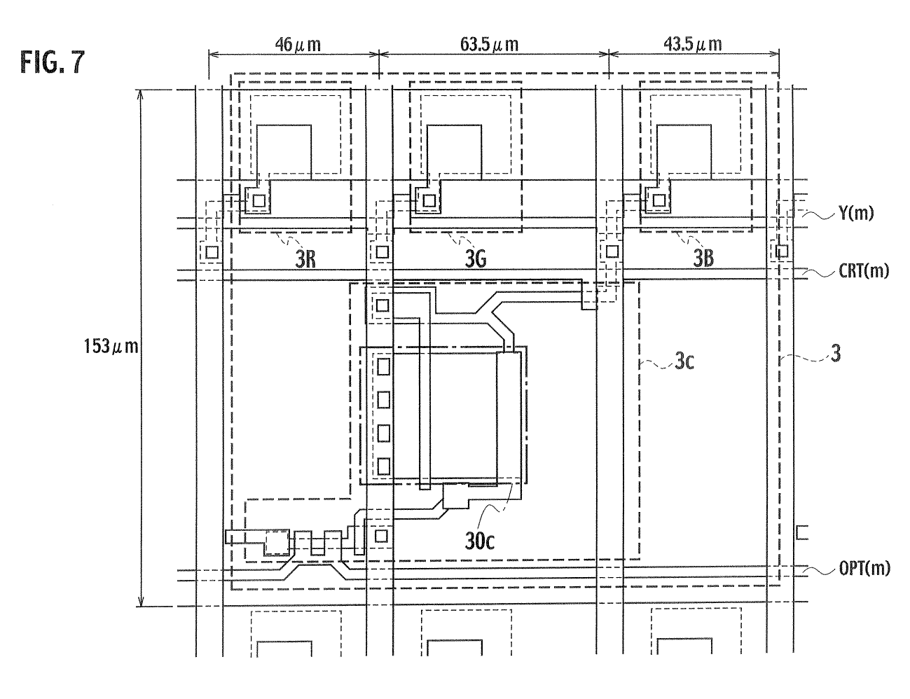

As shown in a layout diagram of a pixel of FIG. 7, an optical sensor 3c is disposed in a sub-pixel 3G of three sub-pixels 3R, 3G and 3B in a pixel 3. The sub-pixel 3G has an area larger than the other sub-pixels 3R and 3B. Here, a ratio of pixel pitches of the sub-pixels 3R, 3G and 3B is 46:63.5:43.5. The green sub-pixel 3G has the area larger than the sub-pixels 3R and 3B. This configuration makes it possible to make the amount of light passing through the respective sub-pixels closer to one another when an image is displayed.

As described above, in the third embodiment, the optical sensor 3c is disposed in the green sub-pixel 3G of the three sub-pixels 3R, 3G and 3B of the pixel 3, the green sub-pixel 3G having the area larger than the other two sub-pixels. Accordingly, the amount of light passing through the respective sub-pixels can be made closer to one another. Hence, it is possible to maintain the white balance regarded as the display performance.

Note that, in the third embodiment, the optical sensor 3c is disposed in the green sub-pixel 3G, but the disposition is not limited to this. For instance, it is possible to adopt a configuration in which the optical sensor 3c is disposed in the sub-pixel 3R or the sub-pixel 3B, as long as the optical sensor 3c is disposed in any one sub-pixel of the three sup-pixels, the one sub-pixel having an area larger than the other two sub-pixels.

In addition, note that, in each of the embodiments described above, the PIN photodiode having the following configuration is adopted as the example of the light-receiving element of the optical sensor, but the light-receiving element is not limited to this. Specifically, the PIN photodiode described above has the i-region between the p-region and the n-region. In the PIN photodiode, in order to increase the light-receiving sensitivity level, the p-region is the p⁺-region having the higher concentration of p-type impurities, the n-region is an n⁺-region having the higher concentration of n-type impurities, and the i-region is the p⁻-region having the lower concentration of p-type impurities. However, for instance, it is also possible to adopt a PIN diode having the lower light-receiving sensitivity level by having a p⁺-region as the p-region, an n⁺-region as the n-region, and a p⁻ or n⁻-region as the i-region. Furthermore, a plurality of PIN diodes, which have light-receiving sensitivity levels different from each other, may be combined and used.

What is claimed is:

1. A display device comprising:
a pixel region having a plurality of pixels;
three sub-pixels of red, green and blue colors disposed in each of the pixels; and
an optical sensor disposed across the three sub-pixels.

2. A display device comprising:
a pixel region having a plurality of pixels;
three sub-pixels of red, green and blue colors disposed in each of the pixels;
an optical sensor disposed in any one of the three sub-pixels; and
dummy patterns respectively disposed in the sub-pixels, in each of which the optical sensor is not disposed.

3. A display device comprising:
a pixel region having a plurality of pixels;
three sub-pixels of red, green and blue colors disposed in each of the pixels, and any one of which three sub-pixels has an area larger than the other two sub-pixels; and
an optical sensor disposed in the sub-pixel having the larger area.
